(19) United States
(12) Patent Application Publication
(10) Pub. No.: US 2024/0269566 A1
(43) Pub. Date: Aug. 15, 2024

(54) SYSTEMS AND METHODS FOR MANAGEMENT OF VIRTUAL AGENTS

(71) Applicant: Interwoven Worlds Inc., Austin, TX (US)

(72) Inventors: Frederick HOWARD, Austin, TX (US); Josef HALL, Cedar Park, TX (US)

(21) Appl. No.: 18/442,958

(22) Filed: Feb. 15, 2024

Related U.S. Application Data
(60) Provisional application No. 63/485,225, filed on Feb. 15, 2023.

(51) Int. Cl. A63F 13/67; A63F 13/54; A63F 13/56; A63F 13/79; G10L 13/02; G10L 15/06; G10L 15/18; G10L 15/183; G10L 15/22

(52) U.S. Cl. CPC A63F 13/67; A63F 13/54; A63F 13/56; A63F 13/79; G10L 13/02; G10L 15/063; G10L 15/1815; G10L 15/183; G10L 15/22; G10L 2015/0635; G10L 2015/223

(57) ABSTRACT

A method may include: receiving, by a computer program, a user speech or a user action from a user of the computer program, the computer program comprising a virtual agent; identifying a user intent from the user speech or the user action; retrieving saved user-specific memories, static data, and an application state for the computer program; generating a prompt based on the user speech or the user action, the saved user-specific memories, the static data, and the application state; providing the prompt to a text generation module and receiving a suggested action for the virtual agent; converting the suggested action into virtual agent speech and a virtual agent action, wherein the virtual agent outputs the virtual agent speech and takes the virtual agent action; and updating the saved user-specific memories, the static data, and/or the application state with the virtual agent speech and the virtual agent action.

### RELATED APPLICATIONS

This application claims priority to, and the benefit of, U.S. Provisional Patent Application Ser. No. 63/485,225, filed Feb. 15, 2023, the disclosure of which is hereby incorporated, by reference, in its entirety.

### BACKGROUND OF THE INVENTION

### 1. Field of the Invention

Embodiments are generally directed to systems and methods for the management of virtual agents.

### 2. Description of the Related Art

Agents, or virtual companions, are common in computer applications. Virtual agents can take any form, and often accompany a player's avatar in gameplay.

### SUMMARY OF THE INVENTION

In embodiments, virtual agents or companions are designed to mimic intelligent, self-thinking creatures with the goal of creating ever growing bonds with their players.

Throughout experiences, players will interact with agents but do not directly control or direct agents.

Data in a virtual agent memory may drive an autonomous behavior AI which leads to agent actions. Stored goals, agent capabilities, stats, the environment as well as other players/agents may influence the virtual agent's actions within the game experiences. Actions that occur during the virtual agent's autonomous actions feed back to the virtual agent memory to keep information accurately updated (example, agent expends energy during actions).

A discrete or combination of set items may trigger a prompt initiation. These triggers flow data into a prompt generation mechanism. A prompt generation layer may initiate a prompt into a Large Language Model (LLM) based on these prompt initiations. As a part of the prompt creation, the system may search through the virtual agent memory and pull in relevant information for addition to the prompt.

The virtual agent memory may be a core component of prompt creation. Since LLMs inherently have no traditional memory and are also limited by prompt input size, the memory creates a mechanism to access an ever-growing storage of key aspects pertaining to the virtual agent, its history, and relationship with the player. This may drive an ever-growing relationship between the player and the virtual agent.

The custom prompt may be fed into an LLM, the text output of which is unpredictable but mimics that of an emotional human-like output. The text output from the LLM may flow into an Interpretation/Action layer which converts the text into buckets: information to update existing or add new data to the virtual agent memory, information to update or add new instructions to the virtual agent autonomous AI, creation of a verbal response back to the player.

The interpretation/action layer may customize uniquely to each player continually driving to responses, actions and memories that deepen the bond between the player and the virtual agent.

According to an embodiment, a method may include: (1) receiving, by a computer program, a user speech or a user action from a user of the computer program, the computer program comprising a virtual agent; (2) identifying a user intent from the user speech or the user action; (3) retrieving saved user-specific memories, static data, and an application state for the computer program; (4) generating a prompt based on the user speech or the user action, the saved user-specific memories, the static data, and the application state; (5) providing the prompt to a text generation module and receiving a suggested action for the virtual agent; (6) converting the suggested action into virtual agent speech and a virtual agent action, wherein the virtual agent outputs the virtual agent speech and takes the virtual agent action; and (7) updating the saved user-specific memories, the static data, and/or the application state with the virtual agent speech and the virtual agent action.

In one embodiment, the computer program may include a game.

In one embodiment, the virtual agent may include an in-game virtual companion.

In one embodiment, the text generation module may include a large language model.

In one embodiment, the saved user-specific memories comprise a history of interactions between the user and the virtual agent.

In one embodiment, the interactions comprise the virtual agent action and the virtual agent speech.

In one embodiment, the application state may include a location of the virtual agent, statistics for the virtual agent, and a status of items in the computer program.

In one embodiment, the method may also include: receiving, from the user, feedback on the virtual agent speech or the virtual agent action; and updating virtual agent traits based on the feedback.

In one embodiment, the prompt may include text based on the user speech or the user action, the saved user-specific memories, the static data, and the application and framing text.

In one embodiment, the virtual agent action may be further based on a goal for the virtual agent.

According to another embodiment, a non-transitory computer readable storage medium, may include instructions stored thereon, which when read and executed by one or more computer processors, cause the one or more computer processors to perform steps comprising: receiving a user speech or a user action from a user of a computer program, the computer program comprising a virtual agent; identifying a user intent from the user speech or the user action; retrieving saved user-specific memories, static data, and an application state for the computer program; generating a prompt based on the user speech or the user action, the saved user-specific memories, the static data, and the application state; providing the prompt to a text generation module and receiving a suggested action for the virtual agent; converting the suggested action into virtual agent speech and a virtual agent action, wherein the virtual agent outputs the virtual agent speech and takes the virtual agent action; and updating the saved user-specific memories, the static data, and/or the application state with the virtual agent speech and the virtual agent action.

In one embodiment, the computer program may include a game.

In one embodiment, the virtual agent may include an in-game virtual companion.

In one embodiment, the text generation module may include a large language model.

In one embodiment, the saved user-specific memories comprise a history of interactions between the user and the virtual agent.

In one embodiment, the interactions comprise the virtual agent action and the virtual agent speech.

In one embodiment, the application state may include a location of the virtual agent, statistics for the virtual agent, and a status of items in the computer program.

In one embodiment, the non-transitory computer readable storage medium may also include instructions stored thereon, which when read and executed by one or more computer processors, cause the one or more computer processors to perform steps comprising: receiving, from the user, feedback on the virtual agent speech or the virtual agent action; and updating virtual agent traits based on the feedback.

In one embodiment, the prompt may include text based on the user speech or the user action, the saved user-specific memories, the static data, and the application and framing text.

In one embodiment, the virtual agent action may be further based on a goal for the virtual agent.

### BRIEF DESCRIPTION OF THE DRAWINGS

For a more complete understanding of the present invention, the objects and advantages thereof, reference is now made to the following descriptions taken in connection with the accompanying drawings in which:

FIGS. 1 and 2 illustrate an architecture for the management of virtual agents according to an embodiment;

FIG. 3 illustrates a method for the management of virtual agents according to an embodiment;

FIG. 4 depicts an exemplary computing system for implementing aspects of the present disclosure.

### DETAILED DESCRIPTION OF PREFERRED EMBODIMENTS

Systems and methods for the management of virtual agents are disclosed.

In embodiments, virtual agents as well as the systems that enable them, with the intention to mimic intelligent, self-thinking creatures are disclosed. For example, although embodiments implement artificial intelligence in the virtual agents, embodiments may also develop ever-strengthening positive bonds between human players and their virtual agents. Embodiments both understand the drivers of positive bonds and to then optimize those drivers between human players and their virtual agents. Because each human player is unique in what ultimately leads to their bonding drivers, embodiments may uniquely customize to each player and agent based on continual feedback loops.

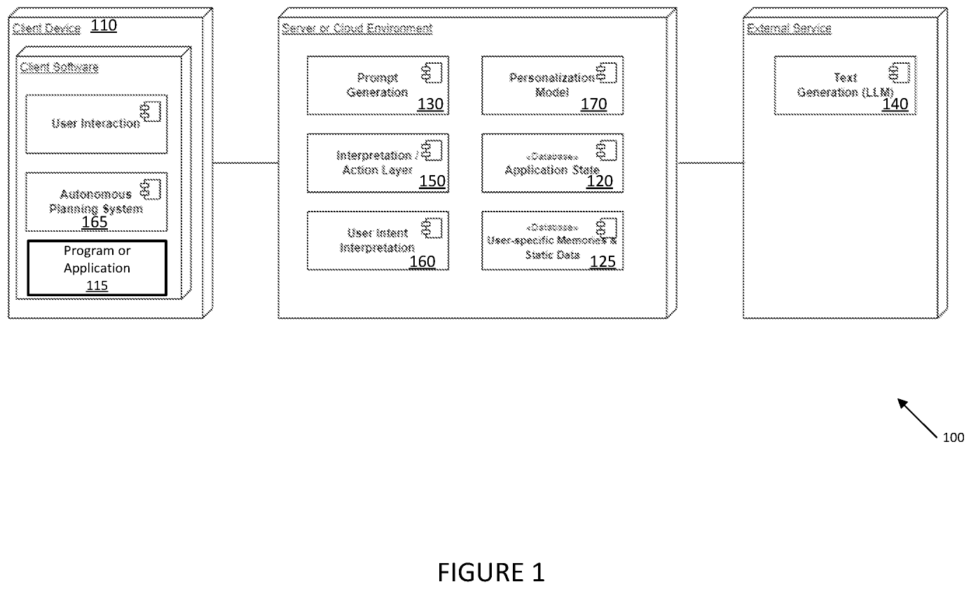

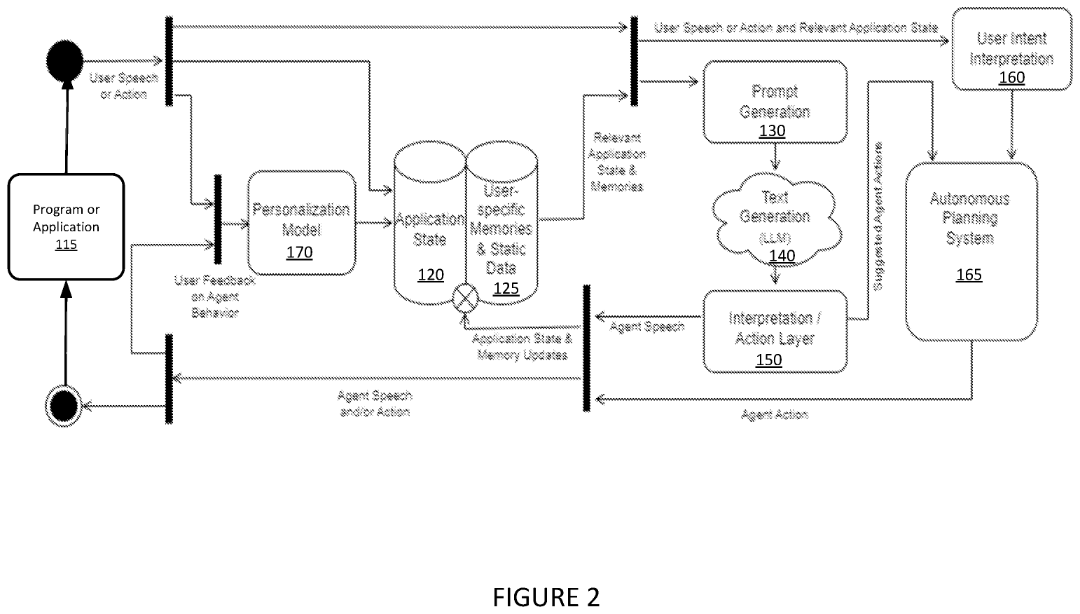

Referring to FIGS. 1 and 2, an architecture for management of virtual agents is disclosed according to an embodiment. System 100 may include a user electronic device 110, which may be a computer (e.g., workstation, desktop, laptop, notebook, tablet, etc.), a smart device (e.g., smart phone, smart watch, etc.), an Internet of Things (IoT) appliance, a kiosk, a terminal, etc. The user electronic device may execute program or application 115, which may be any suitable computer program, such as a game (e.g., single player or multiplayer), an interface to a virtual world (e.g., the Metaverse), a chatbot, a virtual assistant, an operating system, etc.

A user may interact with program or application 115 in the form of an action (e.g., an input via a controller, touchscreen, etc.), live speech, etc. When such an interaction is received, the state of program or application 115 may be saved in application state database 120.

User-specific memories, static data, etc. may be stored in user-specific memories and static data database 125. For example, user-specific memories and static data database 125 may include a record of a user's previous interactions with the virtual agent, such as all communications to and from the virtual agent. It may also include metadata about these communications, such as estimates of the sentiment (positive or negative) expressed in the communication.

In addition, user-specific memories and static data database 125 may contain data about the application or game, representing the virtual agent's “knowledge”. This may be stored as human-readable text. For instance, user-specific memories and static data database 125 may contain descriptions of the game world, the virtual agent's personal history, etc. Such data is often static and set at application or game startup, but may also be added to as the virtual agent “learns” information within the game or as new information becomes available within an application.

Relevant data may be retrieved by prompt generation layer in several ways, including “semantic similarity” in which a machine learning model may be used to calculate a numeric vector representation of a user's communication and of each text item stored in the database. The model may be trained so that text items with similar semantic meanings result in numeric vectors that are nearby to one another in an appropriate metric space, such as cosine similarity. When a user communicates with the virtual agent, vectors from the user-specific memories and static data database 125 that are close to the vector representation of the user's communication are retrieved, and the corresponding stored memories or other application data are retrieved.

Data may also be retrieved by other search and information retrieval methods, such as term frequency-inverse document frequency (TF-IDF) based ranking.

Relevant user-specific memories and static data from user-specific memories and static data database 125 may be received as human readable text. For user-specific memories, this may be the literal text of the relevant communication between the virtual agent and the user, potentially including previous and following communications as context, together with the time of the communication and potentially other metadata. For static data, this may be a sentence or short paragraph describing to the virtual agent what it “knows.”

Once prompt generation layer 130 retrieves the data (e.g., text) from user-specific memories and static data database 125 and/or data from application state database 120, as well as framing text, it may provide the text and framing text to text generation layer 140, such as a large language model. In one embodiment, the framing text may be manually developed by, for example, application designers that may specify specific application state conditions under which particular framing text is selected. For example, if the triggering game state is that the user (“Bob”) just walked into a specific location that happens to have some glowing mushrooms, the framing text might be “paraphrase the following text:” and the relevant static data triggered by the location is “Look at those glowing mushrooms, {{user_name}}!”. Text generation module 140 may receive the following (1) a brief opening stanza describing the virtual agent, its personality and traits; (2) the immediate past history of the most recent conversation between user and agent ; (3) an instruction to please paraphrase the following text: “Look at those glowing mushrooms, Bob!”. The output of text generation module 140 may be something like “Wow, Bob, check out those fluorescent ‘shrooms!”

In embodiments, prompt generation layer 130 may include two components: (1) triggers that initiate a prompt construction and (2) a logic tree that determines the triggers/combination of triggers that will initiate a prompt, and what specifics need to be achieved to trigger that prompt. Examples of prompt initiations may include game data, player inputs, emotional detection, etc.; other prompt types may be used as is necessary and/or desired.

Player inputs may include standard modes of communication, such as tapping buttons in-game, touchscreen interaction, keyboard interaction, or any suitable means of input. Embodiments may also include rich AI-driven modes of interaction, such as speech to text. An example of a suitable speech to text model is Whisper, available from OpenAI.

The generated text may be used as commands for the virtual agent, and a transcribed communication may be passed to the prompt construction layer and incorporated in the virtual agent's response. Other mechanisms for communicating with a virtual agent may be used as is necessary and/or desired, and may be incorporated into the player/agent communication initiation process.

While the primary player input is the human player directly tied to the virtual agent, in embodiments, other humans may also interact and converse with the virtual agent.

Emotional detection mechanisms may help inform the fundamental understanding of the player/agent bond and help in identifying what actions/responses/outcomes lead to strengthening positive bonds. An example of such an input may include direct player feedback (e.g., clicking a thumbs up/down icon, etc.), etc. In embodiments, deep convolutional neural networks that exhibit high accuracy in detecting human emotion through voice analysis, facial analysis and other mechanisms may also be used to assess player emotional state.

Game data input may include a wide variety of information relevant to the particular game/experiences/situation that the player and agent are in. For example:
● a summary of relevant In-Experience environment items (chairs, desks, floors, buildings. etc.);
● object stats (weights, powers, intractability of items, etc.);

● agent stats (health, strength, intelligence, powers, attacks, defenses, etc.);
● agent mood (e.g., hunger level, exhaustion level, happiness level, etc.);
● external stimulus (e.g., NPCs, other agents, in-game environment like weather, etc.);
● agent objectives including goals and win scenarios; and
● location of player and agent (e.g., are they in the lair, or in an arena match, or in other areas where latency matters).

The game data that is stored in the virtual agent memory (e.g., in application state database 120 and/or user-specific memories and static data database 125) may both initiate and be included in the prompt generation.

Prompt generation module 130 may also include a dynamic decision tree that determines when an actual prompt should be generated. For example, some inputs, like player conversation, may always generate a prompt. For other inputs, certain levels/metrics/scenarios must be achieved before a prompt is generated. For example, an agent's health may have to go down by over 10% to trigger a prompt.

The prompt is effectively the “question” for the virtual agent to answer. The wording of the request is important. The model has volumes of information and behaviors stored inside of its neural parameters and the prompt is what will elicit the desired output. Embodiments may analyze the current game state, including current game objects, player input (both traditional and AI-driven) and may construct a dynamic prompt for the behavioral layer.

A component in prompt creation is the limitation in the number of tokens that can pass into text generation module 140. By dynamically tuning and adjusting the prompts during gameplay and tying in player emotional feedback, embodiments may grow and learn alongside the player. Prompts may be constructed using symbolic (traditional) programming approaches that may be augmented with supplementary neural nets for context abstraction, translation and ultimately “knowing” how to construct the richest and most accurate prompt given the current scenario. The prompts may communicate the game state as it bounds options, and may also communicate legitimate game choices that are currently available to the virtual agent.

Prompt generation module 130 may grow to understand which components of the application state and/or user-specific memories and static data are critical for the prompt currently being created.

Once the prompt generation module 130 has constructed a prompt, the prompt may be provided to text generation module 140.

Interpretation/action layer 150 may receive the output of text generation layer 140 and may transform the output of text generation layer to speech, text, or an action for a virtual agent, such as a virtual companion.

For example, agent speech may be stored in user-specific memories and static data database 125. It may be stored with a timestamp, other metadata (e.g., a sentiment analysis score). etc.

In embodiments, interpretation/action layer 150 may take the text and parse it into three interpretation/action buckets: (1) agent memory update; (2) autonomous behavior update; and (3) verbal response (note, while the verbal response is typically to the human player attached to the virtual agent, the verbal response can also be to other human players or to other NPCs within the games or experiences). Interpretation/action layer 150 may send instructions to one or more of these buckets, and may scan and interpret the output of text generation module 140 to send the appropriate responses.

Interpretation/action layer 150 may pull out and recraft an appropriate verbal response based on the output from text generation module 140. This may include text, oral speech, emoji, or any other potential mechanism of communication. It should also be noted that interpretation/action layer 150 may recognize various specifics to the entities receiving the verbal response such that the response may take different formats for various entities. For example, a child player may only see an emoji response while an adult player may see written text or hear oral communication. Likewise, two human players with different language settings may each uniquely see/hear the response in their native language.

Interpretation/action layer 150 may continually learn and improve as the detection is refined and tuned using a series of heuristics developed via testing. In embodiments, this layer may include a Deep Learning Transformer-based language model that may map LLM logits into desired game actions. This may require a significant amount of stored game data.

Actions taken may be stored in application state database 120. For instance, if the user instructs a virtual agent to go get a snack, and, after interpretation by text generation module 140 and autonomous planning component, it went to the kitchen and ate an apple, the apple would be removed from the game world and the virtual agent's “hunger” stat may be decreased. If the user instructs the virtual agent to take a nap, and the virtual agent did so, its “tiredness” stat would decrease.

Other application states, such as the location of the virtual agent, the current quest for the user (e.g., the current objective of the user), etc. may be stored in application state database 120. Other application states may be saved and updated as is necessary and/or desired.

Application state database 120 and user-specific memories and static data database 125 may store the virtual agent memory that may inform how prompts are constructed and may be used to create life-like agents. In embodiments, the memory system may be broken into long term, short term, and game memory layers. While all layers can be accessed at any time, the creation of these partitions makes it easier for the prompt generation layer 130 to know which, if any, layers of the memory should be queried depending on the trigger(s) and context of the trigger(s).

Short term memory may include stats and attributes that change on a regular basis and that may have a meaningful impact on the types of inputs and responses expected from the virtual agent. While not an exhaustive list, below is an example of the types of data that reside in the short term memory:
● hunger level;
● energy level;
● happy/sad scale; and
● tired/alert scale.

User-specific memories and static data database 125 may store a long-term memory, which may be germane to the virtual agent and does not change over time (i.e., the static data) or learned from shared player experiences over time (e.g., the user-specific memories). For example, for user-specific memories, a history of conversations with one player are not shared with another player.

While it is possible to alter data in long-term memory, generally data in long term memory data is fixed once added and will continue to grow over the life of the virtual agent. While not exhaustive, below is a list of the categories of data stored in long term memory:
● agent backstory—This is the data that provides context for the pre-existing background of the virtual agent prior to their meeting the human player (e.g., their childhood, where they're from, siblings, etc.);
● agent personality-Data that provides context to how they should behave based on personality traits such as introvert/extravert, communication style (e.g., snarky, reverent, etc.), bravery and combat style reside in the long term memory;
● shared experiences-Shared experiences between the human player and the virtual agent reside in the long term memory and can be accessed at future dates. Thus players may have interactions with the virtual agents and recall information on experiences that happened in the past. These memories cross a broad range of experiences including combats, conversations, quests, and outcomes on any number of potential activities;

Outcomes may be stored in application state database 120. Data on previous outcomes to any number of scenarios may be stored here and is accessible as a critical “learning” opportunity for both the virtual agent and the human player. Having the data on how previous efforts/initiatives/actions led to various outcomes will help the virtual agent become “wiser” on how to drive different outcomes in the future.

Program or application 115 may receive the virtual agent speech and/or action and may present it to the user. For example, program or application 115 may cause the virtual agent to execute the action graphically, may output audio of the speech, may present text of the speech, etc. The exact response to the virtual agent speech/action may depend on the program or application 115.

System 100 may further include user intent interpretation 160 and autonomous planning system 165. User intent interpretation 160 may receive the user speech or action and the relevant application state from application state database 120. User intent interpretation 160 may receive the user speech and may convert the user speech into a structured statement. For example, if user intent interpretation 160 receives user speech such as “Hey Fluffy, go over to that crystal” it may convert the speech into [Fluffy]->[MOVE TO]->[crystal] event.

The application state may be considered in identifying the user intent from the user speech.

Autonomous planning system 165 may receive suggested agent actions from interpretation/action layer 150 and, using the interpretation of the user intent from user intent interpretation 160, may determine a virtual agent action for the virtual agent. For example, the communications may trigger an immediate response (e.g., trigger a virtual agent animation) or a stored response (e.g., data that changes the scripting or decision tree layers of autonomous planning system 165). The virtual agent speech from interpretation/action layer 150 and the virtual agent action from autonomous planning system 165 may be stored in application state database 120 and/or user-specific memories and static data database 125, and may be provided to program or application 115 to implement.

In one embodiment, autonomous planning system 165 may be implemented through a goal-oriented action planning (GOAP) technique. Here, the virtual agent may have a large number of potential goals, each having associated numeric priority and cost scores. Goals may include, for example, “eat”, “sleep”, “take cover” (in combat scenarios), “find out more about the player”, “act to befriend the player”, etc. The priority score for a given goal may be influenced by current application state from application state database 120. For instance, the priority of “eat” would be increased by a high “hunger” value, the priority of “act to befriend the player” may be increased by a low player “bonding score” value, etc.

Expressed user intentions may also influence goal priorities. For instance, a user suggestion that the virtual agent “go take a nap” may temporarily increase the priority of the “sleep” goal. Such influence may itself be further modulated by game state; for instance, if the virtual agent has a low “happiness” or “trust” statistic value, user-suggested actions might have a lower or even negative impact on goal priorities.

Goal costs may be determined based on an estimate of the time and/or other application resources needed to achieve a particular goal. For instance, the cost of an “eat” goal may be greater if the only available food resource were some distance away.

In embodiments, only a single goal may be active at any time. A virtual agent may choose specific actions to achieve the active goal through decision trees or other algorithmic methods.

Action selection may be influenced by the application state. For instance, the actions available to achieve a “befriend the player” goal may include “write a note,” “paint a picture,” etc. Previous positive user feedback in response to the “paint a picture” action may increase the probability that this action is selected again in the future. In embodiments, such reweighting of actions may be achieved through epsilon-greedy reinforcement learning or other reinforcement learning algorithms.

In embodiments, autonomous planning system 165 may incorporate scripting and decision tree programs, and may also include a virtual agent layer AI that incorporates data from the virtual agent memory (e.g., from application state database 120 and/or user-specific memories and static data 125) as well as information in the scripting and decision tree programming to create evolving agent behaviors. It may also use the outputs of interpretation/action layer 150 to add or overwrite data in application state database 120 and/or user-specific memories and static data 125. Since the application state database 120 and/or user-specific memories and static data 125 fuels autonomous planning system 165, updating the application state database 120 and/or user-specific memories and static data 125 in effect updates the virtual agent's behavior. Further, interpretation/action layer 150 outputs may rewrite components of the scripting and decision tree programming further allowing the virtual agent's autonomous behavior to evolve.

System 100 may further include personalization model 170, which may receive user speech or action from program or application 115, as well as user feedback on the virtual agent speech and/or action provided by interpretation/action layer 150. Personalization model 170 may be trained with the user feedback, and the user feedback may be stored in application state database 120 and/or user-specific memories and static data 125.

In embodiments, personalization model 170 may include an overarching deep learning layer that may monitor engagement and session outcomes. For example, event data may be captured from play sessions and loss functions may measure desired gameplay scenarios. Once the volume of this data is sufficient, personalization model 170 may start to self-adjust for desired agent behavior via improved prompt crafting at an individual player level:
● at a meta level, the deep learning network may monitor key metrics as well as the behaviors that contributed to the outcome;
● As data volumes become sufficient, player categorizations begin to form based on player preferences and bonding strength;
● as data grows, the deep learning network will ever more quickly categorize new players into appropriate categories;
● the deep learning network initiates changes to the virtual agent

Artificial Intelligence Architecture components based on player preference categorization;
● continued data growth creates more and more refined categorizations of player preferences for driving deeper positive bonds and increasing speeds-individualized player experiences.

The deep learning network may look at a series of traditional gaming metrics as well as direct player feedback to begin to learn what types of interactions, styles and outcomes drive deepening player bonding with their agent. For example, the initial metrics may include:
● player time in game;
● player time interacting with their agent;
● frequency of game sessions;
● frequency of agent interactions;
● player revenue; and
● player retention.

More traditional machine learning techniques, such as XGBoost, etc. may be used to monitor and optimize desired Key Performance Indicators (KPIs) such as daily retention, session length, monetization, LTV, etc. These techniques may effectively perform customer segmentation and early behavior prediction for a customer population. As the deep learning network learns, it may categorize players into player subgroups all exhibiting the same types of behaviors and preferences. As more data is accumulated, the learning enables customization for new players at a quicker and more accurate level, essentially creating a growing ability to attract, retain and grow more customers at a faster clip. Likewise, increasing data enables deeper and deeper segmentation and almost unique customization of the virtual agent artificial intelligence architecture down to individual player levels.

In embodiments, user feedback may be received as part of user speech or action from program or application 115, or separately, as negative feedback or positive feedback. For example, a user may say “Stop it!”, which may be interpreted as negative feedback on the virtual agent's recent speech or action. The feedback may be aggregated and stored in application state database 120, and may be used to update further agent speech and actions. As another example, a virtual agent trait, such as a “sarcasm” trait in the virtual agent LLM prompt, which can range from “You are tremendously sarcastic” through “You are prone to light-hearted banter” up to “You are earnest and sincere” may be set directly or inferentially based on feedback from the user.

Initial values may be established during setup.

In one embodiment, the feedback may be referred to as a “bonding score,” and may be based on a sentiment expressed by the user towards the virtual agent (e.g., “Stop it!” is a negative example, “You're great, Fluffy” is a positive example, “I hate apples” is neutral because it's not directed towards the virtual agent.), and directiveness. The user should be interacting with the virtual agent as if the virtual agent were a living being. If the user says “Pick up the crystal”, the user is not treating the virtual agent as a living being. “Fluffy, could you please pick up the crystal?” is closer to such treatment. “Pick up the crystal” is highly directive, which is negative for the overall bonding score; “Fluffy, could you please pick up the crystal” is much less directive and so is positive for the bonding score.

The individual scores may be calculated by another call to a second large language model (not shown) or by a different machine learning model. For example, the LLM may be provided with “directiveness” to the LLM in text with a request to rate the directiveness of a statement on a scale, such as from-3 to 3 (currently). Examples of statements with training scores may be provided to the LLM as well. The scores that are received from the LLM may be decayed over time so that more recent scores affect the overall current bonding score more strongly than scores attached to speech that happened long ago.

In embodiments, feedback on the virtual agent's traits may be received. For each user statement, embodiments may determine a “humor/sarcasm” score (which may be similar to the way that the bonding score is determined). Embodiments may assume a “mirroring” principle, where a player that is more sarcastic to their agent would prefer a virtual agent that is more sarcastic back to them. Recent player humor makes the virtual agent more sarcastic, a player who does not say anything funny gets a very straight-arrow agent.

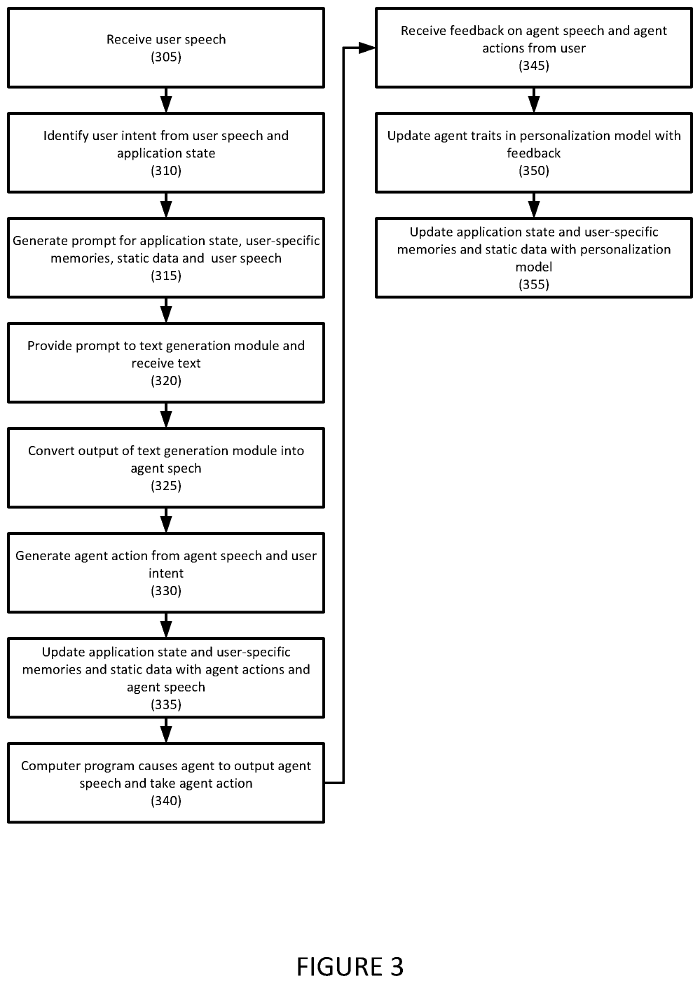

Referring to FIG. 3, a method for management of virtual agents is provided according to an embodiment.

In step 305, a computer program or application may receive user speech or an action. In one embodiment, the user speech or action may be received as part of a game, as part of an interaction with a computer program (e.g., a chatbot, an operating system, etc.).

In step 310, the user intent from the user speech or action may be identified. For example, using the user speech or action, and a saved state for the application, the user's intent may be discerned.

In step 315, using the user speech or action, saved user-specific memories, static data, and the application state, a prompt may be generated.

In step 320, the prompt may be provided to a text generation module, which may process the prompt and output text, such as a suggested agent action.

In step 325, the output of the text generation module may be converted into agent speech.

In step 330, using the user intent and the output of the text generation module, a virtual agent action may be generated.

In step 335, the application state, the user-specific memories, and the static data may be updated with the virtual agent actions and agent speech.

In step 340, the computer program may cause the virtual agent to output the speech and to take the action.

In step 345, the user may provide feedback on the virtual agent action and/or speech. For example, the user may utter additional speech or take another action, and the user's sentiment from the speech or action may be identified.

In step 350, the virtual agent's traits in a personalization model may be updated based on the feedback.

In step 355, the application state, user-specific memories, and static data may be updated with the personalization model.

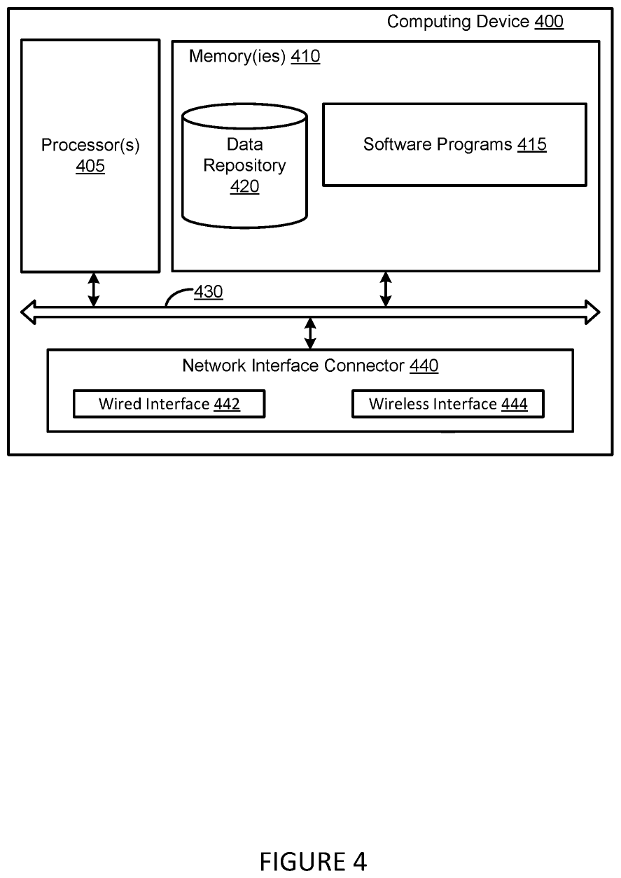

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program, a user speech or a user action from a user of the computer program, the computer program comprising a virtual agent;
identifying a user intent from the user speech or the user action;
retrieving saved user-specific memories, static data, and an application state for the computer program;
generating a prompt based on the user speech or the user action, the saved user-specific memories, the static data, and the application state;
providing the prompt to a text generation module and receiving a suggested action for the virtual agent;
converting the suggested action into virtual agent speech and a virtual agent action, wherein the virtual agent outputs the virtual agent speech and takes the virtual agent action; and
updating the saved user-specific memories, the static data, and/or the application state with the virtual agent speech and the virtual agent action.

2. The method of claim 1, wherein the computer program comprises a game.

3. The method of claim 2, wherein the virtual agent comprises an in-game virtual companion.

4. The method of claim 1, wherein the text generation module comprises a large language model.

5. The method of claim 1, wherein the saved user-specific memories comprise a history of interactions between the user and the virtual agent.

6. The method of claim 5, wherein the interactions comprise the virtual agent action and the virtual agent speech.

7. The method of claim 1, wherein the application state comprises a location of the virtual agent, statistics for the virtual agent, and a status of items in the computer program.

8. The method of claim 1, further comprising:
receiving, from the user, feedback on the virtual agent speech or the virtual agent action; and
updating virtual agent traits based on the feedback.

9. The method of claim 1, wherein the prompt comprises text based on the user speech or the user action, the saved user-specific memories, the static data, and the application and framing text.

10. The method of claim 1, wherein the virtual agent action is further based on a goal for the virtual agent.

11. A non-transitory computer readable storage medium, including instructions stored thereon, which when read and executed by one or more computer processors, cause the one or more computer processors to perform steps comprising:
receiving a user speech or a user action from a user of a computer program, the computer program comprising a virtual agent;
identifying a user intent from the user speech or the user action;
retrieving saved user-specific memories, static data, and an application state for the computer program;
generating a prompt based on the user speech or the user action, the saved user-specific memories, the static data, and the application state;
providing the prompt to a text generation module and receiving a suggested action for the virtual agent;
converting the suggested action into virtual agent speech and a virtual agent action, wherein the virtual agent outputs the virtual agent speech and takes the virtual agent action; and
updating the saved user-specific memories, the static data, and/or the application state with the virtual agent speech and the virtual agent action.

12. The non-transitory computer readable storage medium of claim 11, wherein the computer program comprises a game.

13. The non-transitory computer readable storage medium of claim 12, wherein the virtual agent comprises an in-game virtual companion.

14. The non-transitory computer readable storage medium of claim 11, wherein the text generation module comprises a large language model.

15. The non-transitory computer readable storage medium of claim 11, wherein the saved user-specific memories comprise a history of interactions between the user and the virtual agent.

16. The non-transitory computer readable storage medium of claim 15, wherein the interactions comprise the virtual agent action and the virtual agent speech.

17. The non-transitory computer readable storage medium of claim 11, wherein the application state comprises a location of the virtual agent, statistics for the virtual agent, and a status of items in the computer program.

18. The non-transitory computer readable storage medium of claim 11, further including instructions stored thereon, which when read and executed by one or more computer processors, cause the one or more computer processors to perform steps comprising:
receiving, from the user, feedback on the virtual agent speech or the virtual agent action; and
updating virtual agent traits based on the feedback.

19. The non-transitory computer readable storage medium of claim 11, wherein the prompt comprises text based on the user speech or the user action, the saved user-specific memories, the static data, and the application and framing text.

20. The non-transitory computer readable storage medium of claim 11, wherein the virtual agent action is further based on a goal for the virtual agent.
